(19) United States
(12) Patent Application Publication
(10) Pub. No.: US 2026/0073302 A1
(43) Pub. Date: Mar. 12, 2026

(54) METHOD, APPARATUS, DEVICE, AND STORAGE MEDIUM FOR TRAINING MODEL

(71) Applicants: Beijing Zitiao Network Technology Co., Ltd., Beijing (CN); Lemon Inc., Grand Cayman (KY)

(72) Inventors: Yiqing LU, Beijing (CN); Zhongyi Huang, Beijing (CN); Qingqing Huang, Los Angeles, CA (US); Jitong Chen, Los Angeles, CA (US); Shuo Zhang, Beijing (CN); Lamtharn Hantrakul, Beijing (CN)

(21) Appl. No.: 19/321,042

(22) Filed: Sep. 5, 2025

(30) Foreign Application Priority Data
Sep. 6, 2024 (CN) 202411251956.9

(51) Int. Cl. G06N 20/00

(52) U.S. Cl. CPC G06N 20/00

(57) ABSTRACT

A method, an apparatus, a device, and a storage medium for training a model are provided. First audio content associated with vocal content is extracted from a music sample. First annotation information is generated based on the first audio content, and the first annotation information includes text content corresponding to the first audio content and first melody information of the first audio content. A first training sequence is constructed based on the text content and the first melody information. The first training sequence is input to a music generation model to generate a first set of music encoded representations. The music generation model is trained based on the first set of music encoded representations and a second set of music encoded representations of the music sample.

### CROSS REFERENCE

This application claims priority to Chinese Application No. 202411251956.9, filed on Sep. 6, 2024 and entitled “METHOD, APPARATUS, DEVICE, AND STORAGE MEDIUM FOR TRAINING MODEL”, the entirety of which is incorporated herein by reference.

### FIELD

Example embodiments of the present disclosure generally relate to the field of computers, and in particular, to a method, an apparatus, a device, and a computer-readable storage medium for training a model.

### BACKGROUND

With the development of machine learning technologies, machine learning models have been utilized to perform tasks in a variety of application environments. Artificial Intelligence Singing Voice Synthesis (SVS) is a computer technology that attempts to simulate human singing. The SVS may be regarded as a special branch of Text to Speech (TTS). In the process of synthesizing songs by using the SVS, not only the intelligibility of the language needs to be maintained, but also the music features such as timbre, pitch, duration, and singing style are copied as much as possible. However, the current SVS technology still has some problems, affecting the quality of the synthesized song.

### SUMMARY

In a first aspect of the present disclosure, a method of training a model is provided. The method includes: extracting, from a music sample, first audio content associated with vocal content: generating first annotation information based on the first audio content, the first annotation information including text content corresponding to the first audio content and first melody information of the first audio content: constructing a first training sequence based on the text content and the first melody information: inputting the first training sequence to a music generation model to generate a first set of music encoded representations; and training the music generation model based on the first set of music encoded representations and a second set of music encoded representations of the music sample.

In a second aspect of the present disclosure, an apparatus for training a model is provided. The apparatus includes: an extraction module configured to extract, from a music sample, first audio content associated with vocal content: a first generation module configured to generate first annotation information based on the first audio content, the first annotation information including text content corresponding to the first audio content and first melody information of the first audio content: a construction module configured to construct a first training sequence based on the text content and the first melody information: a second generation module configured to input the first training sequence to a music generation model to generate a first set of music encoded representations; and a training module configured to train the music generation model based on the first set of music encoded representations and a second set of music encoded representations of the music sample.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a non-transitory computer-readable storage medium is provided. The non-transitory computer-readable storage medium has a computer program stored thereon, and the computer program is executable by a processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements. In the drawings:

FIG. 1 illustrates a schematic diagram of an example environment in which embodiments of the present disclosure may be implemented;

FIG. 2 illustrates an example architecture diagram of an example of a model training system according to some embodiments of the present disclosure:

FIG. 3 illustrates an example architecture diagram of an example of a model fine-tuning system according to some embodiments of the present disclosure:

FIG. 4 illustrates an example architecture diagram of another example of a model fine-tuning system according to some embodiments of the present disclosure:

FIG. 5 illustrates an example architecture diagram of an example of a melody element according to some embodiments of the present disclosure:

FIG. 6 illustrates an example architecture diagram of an example of a music generation system according to some embodiments of the present disclosure:

FIG. 7 illustrates a flowchart of a process for training a model according to some embodiments of the present disclosure:

FIG. 8 illustrates a block diagram of an apparatus for training a model according to some embodiments of the present disclosure; and

FIG. 9 illustrates a block diagram of a device capable of implementing various embodiments of the present disclosure.

### DETAILED DESCRIPTION

It is understood that, before the technical solutions disclosed in the embodiments of the present disclosure are used, types, usage scopes, usage scenarios and the like of personal information related to the present disclosure should be notified to the user in an appropriate manner according to the relevant laws and regulations and the authorization should be obtained from the user.

For example, in response to receiving an active request from a user, prompt information is sent to the user to explicitly prompt the user that the requested operation will need to acquire and use the personal information of the user, Thus, the user can autonomously select whether to provide personal information to software or hardware such as an electronic device, an application, a server, a storage medium or the like executing the operation of the technical solution of the present disclosure according to the prompt information.

As an optional but non-limiting implementation, in response to receiving the active request from the user, the prompt information may be sent to the user, for example, in a manner of a pop-up window, and the prompt information may be presented in a text manner in the pop-up window. In addition, the pop-up window may further carry a selection control for the user to select “agree” or “not agree” to provide personal information to the electronic device.

It may be understood that the foregoing notification and obtaining a user authorization process are merely illustrative, and does not constitute a limitation on implementations of the present disclosure, and other manners of meeting related laws and regulations may also be applied to implementations of the present disclosure.

It can be understood that the embodiments of the present disclosure relate to the training and inference of the model, and the data involved in the training and inference of the model (including but not limited to the data itself, the acquisition or use of the data) should follow the requirements of the corresponding laws and regulations and related provisions.

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or different sections/subsections.

Herein, unless explicitly stated. “in response to A” performs one step and does not imply that this step is performed immediately after “A”, but may include one or more intermediate steps.

In the description of the embodiments of the present disclosure, the terms “including” and the like should be understood to be an open-ended inclusion. i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first”, “second”, and the like may refer to different or identical objects. Other explicit and implicit definitions may also be included below:

As used herein, the term “model” may learn association(s) between respective input(s) and output(s) from training data such that a corresponding output may be generated for a given input after training is completed. The generation of the model may be based on a machine learning technique. Deep learning is a machine learning algorithm that processes an input and provides a corresponding output by using a multi-layer processing unit. The “model” may also be referred to herein as a “machine learning model”. “machine learning network”, or “network”, which terms are used interchangeably herein. A model may also include different types of processing units or networks.

As used herein, a “unit”, an “operation unit”, or a “subunit” may be composed of a machine learning model or network of any suitable structure. As used herein, a set of elements or similar expressions may include one or more such elements. For example, a “set of convolution units” may include one or more convolution units.

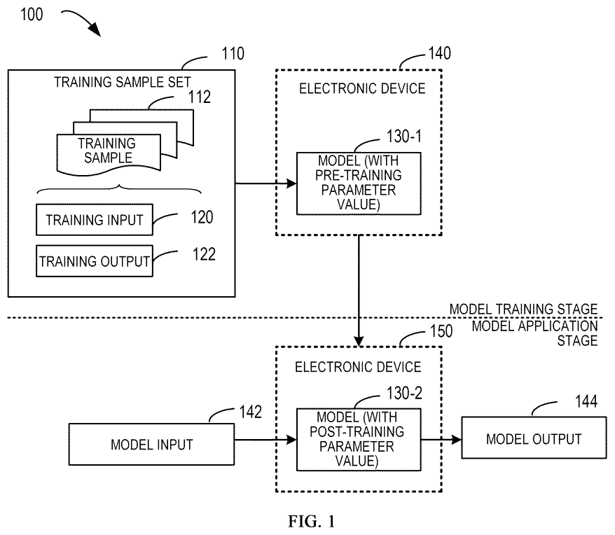

FIG. 1 illustrates a schematic diagram of an example environment 100 in which embodiments of the present disclosure may be implemented. As shown in FIG. 1, a model 130-1 with a pre-training parameter value and a model 130-2 with a post-training parameter value may be collectively or individually referred to as a model 130. The model 130 may be implemented or included in the electronic device 140.

In the environment 100 of FIG. 1, it is desirable to train and use such a machine learning model (i.e., the model 130) configured for a variety of application environments. For example, in the case that the model is a speech synthesis model, speech corresponding to a text may be generated based on a reference speech and the text input by the user, or speech information input by the user may be edited, etc. For example, in the case that the model 130 is a singing voice synthesis model, corresponding song audio and the like may be generated based on musical score information and vocal singing information input by the user.

As shown in FIG. 1, the environment 100 includes an electronic device 140 and/or an electronic device 150, There may be a model training system in the electronic device 140, and there may be a model application system in the electronic device 150, The upper part of FIG. 1 illustrates a process of the model training stage, and the lower part illustrates a process of the model application stage, Before training, the parameter value of the model 130 may have an initial value, or may have a parameter value obtained through a pre-training process. The model 130-1 may be trained via forward propagation and backpropagation, during which the parameter values of the model 130-1 may be updated and adjusted. The model 130-2 may be obtained after training is completed. At this time, the parameter value of the model 130-2 has been updated, and based on the updated parameter value, the model 130-2 may be used to implement a singing voice synthesis task at the model application stage.

In the model training stage, the model 130 may be trained based on a training sample set 110 including a plurality of training samples 112 and using the model training system, Here, each training sample 112 may relate to a binary tuple format. For example, for a singing voice synthesis task, the training sample 112 may include a training input 120 and a training output of the singing voice synthesis task. The training input in the singing voice synthesis task may include, for example, a reference audio and a musical score. The training sample 112 including the training input 120 and the training output 122 may be used to train the model 130, Specifically, the training process may be iteratively performed by using a large number of training samples, After training is completed, the model 130 may include knowledge about a task to be processed. In the model application stage, the model 130 (the model 130 at this time has a post-training parameter value) may be used to perform a corresponding task. For example, a model input 142 in the singing voice synthesis task may be received and a corresponding model output 144 is output.

In FIG. 1, the electronic device 140 may include any computing system having computing capabilities, such as various computing devices/systems, terminal devices, servers, and the like. The terminal device may relate to any type of mobile terminal, fixed terminal, or portable terminal, including a mobile phone, a desktop computer, a laptop computer, a notebook computer, a netbook computer, a tablet computer, a media computer, a multimedia tablet, or any combination thereof, including accessories and peripherals of these devices, or any combination thereof. The server includes, but is not limited to, a mainframe, an edge computing node, a computing device in a cloud environment, and the like.

It should be understood that the components and arrangements in the environment 100 shown in FIG. 1 are merely examples, and that the computing system suitable for implementing the example implementations described in the present disclosure may include one or more different components, other components, and/or different arrangements. The implementations of the present disclosure are not limited in this regard.

As briefly mentioned above, the singing voice synthesis technology is used to generate a song from input text and notes. The singing voice synthesis technology includes splicing synthesis technology and artificial intelligence (AI) synthesis technology. The AI synthesis technology learns musical features such as a timbre, a pitch, a phoneme duration, and a singing style of a human voice sample with a machine learning model.

At present, the mainstream singing voice synthesis technology is a model represented by DiffSinger. The DiffSinger is a method for singing voice synthesizing based on a diffusion model, which enhances the control of the singing voice by adding parameters such as a pitch, force, gender, energy and the like to generate a song satisfying the demand.

However, the currently used DiffSinger model is based on phoneme modeling. In the model building process, a large amount of manually annotated phoneme data is required, and the modeling cost is increased. Meanwhile, the manual annotation information in the phoneme data may also destroy the regularity of the duration of the note in the musical score. Therefore, the duration of each phoneme needs to be predicted by using an additional phoneme duration prediction model, thereby further increasing the cost of the training model.

An embodiment of the present disclosure provides a solution for training a model. According to various embodiments of the present disclosure, first audio content associated with vocal content is extracted from a music sample. First annotation information is generated based on the first audio content, and the first annotation information includes text content corresponding to the first audio content and first melody information of the first audio content. A first training sequence is constructed based on the text content and the first melody information. The first training sequence is input to a music generation model to generate a first set of music encoded representations. The music generation model is trained based on the first set of music encoded representations and a second set of music encoded representations of the music sample.

In this way, on one hand, a training sequence is constructed through the text content and the melody content to train the music generation model. It is unnecessary to use the phoneme data, reducing the training cost of the model. On the other hand, the music generation model is trained based on the first set of music encoded representations and the second set of music encoded representations of the music sample with model generation, further improving the performance of the model.

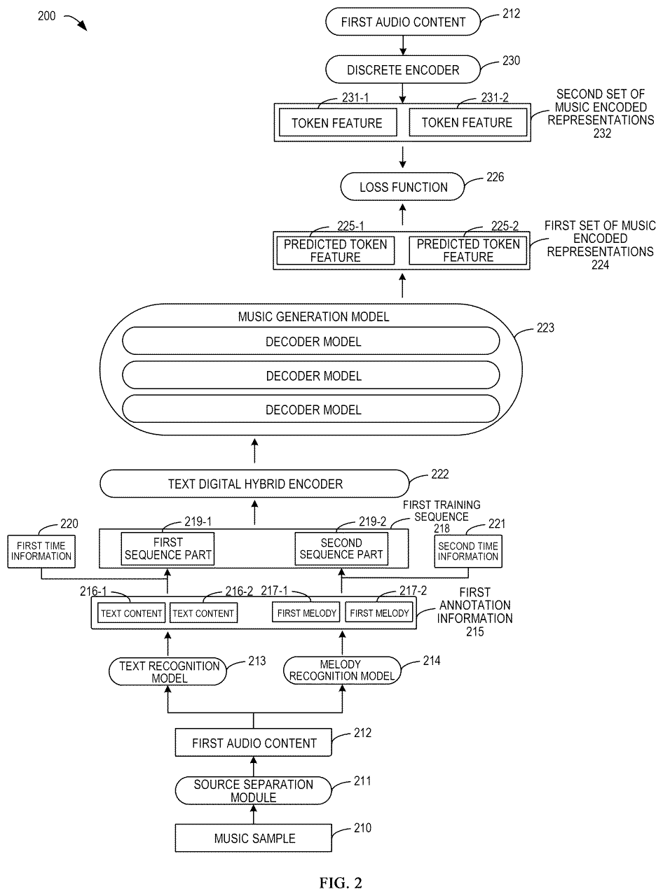

FIG. 2 illustrates an example architecture diagram of an example of a model training system 200 according to some embodiments of the present disclosure. As shown in FIG. 2, the model training system may be implemented or included in the electronic device 140. The electronic device 140 is configured to train a music generation model 223 according to a music sample 210 provided by the user to update a parameter of the music generation model 223.

In some embodiments, first audio content 212 is a vocal track singing associated with the singing content. The vocal track singing is provided to the music generation model 223 to train the music generation model 223 according to the first audio content 212.

In some embodiments, as shown in FIG. 2, the electronic device 140 pre-trains the music generation model 223 according to the provided music sample 210. The music sample 210 is music data containing vocal track information. The music data may be existing music data including voice track information and reverberation, or music that includes only voice track information recorded in a high standard recording environment. As described above, the music sample 210, including but not limited to itself, its acquisition, and/or its use, follows related laws and regulations and provisions.

If the music sample 210 is existing data containing reverberation and voice track information, it is necessary to extract the first audio content 212 (i.e., the voice track singing) associated with the vocal content from the music sample 210. In some embodiments, the music sample 210 may be separated by using a source separation module 211 to obtain the voice track information in the music sample 210. The first audio content 212 may include a plurality of vocal track singings.

In some embodiments, the first audio content 212 is provided into a text recognition model 213 and a melody recognition model 214 to obtain first annotation information 215 generated by the text recognition model 213 and the melody recognition model 214. The first annotation information 215 includes text content corresponding to the first audio content 212 and first melody information of the first audio content 212. The text content includes text 216-1, text 216-2, and the like, which may be individually or collectively referred to as text content 216. The first melody information includes a first melody 217-1, a first melody 217-2, and the like, which may be individually or collectively referred to as a first melody 217.

The text recognition model 213 may be a model constructed based on automatic speech recognition (ASR). The text recognition model 213 converts the input acoustic features into a text sequence. Subsequently, the text sequence is subjected to part-of-speech tagging, syntactic analysis, and semantic understanding to obtain the annotated text content 216 corresponding to the first audio content 212. The melody recognition model 214 may be constructed based on a voice midi recognition technique. The melody recognition model 214 is configured to annotate a melody corresponding to the first audio content 212 to obtain the annotated first melody information.

The model training system constructs a first training sequence according to the text content 216 generated by the text recognition model 213 and the first melody information generated by the melody recognition model 214. The first training sequence 218 is used to train the music generation model 223. The first training sequence includes a first sequence part 219-1 corresponding to the text content 216 and a second sequence part 219-2 corresponding to the first melody information.

In order to generate high-quality music, in some embodiments, the model training system needs to determine time information corresponding to respective lyrics elements in the text content 216 according to the music sample 210, that is, determine, in the music sample 210, an occurrence time and duration of respective lyrics element in the text content 216.

The first sequence part 219-1 is determined from the text content 216 and first time information 220 corresponding to the text content 216. The first sequence part 219-1 includes the text content 216 and a time distribution corresponding to respective lyrics element in the text content 216. The time distribution of respective lyrics element in the text content 216 indicates an occurrence time and a duration of the respective lyrics element. For example, if the text content 216 corresponding to the first audio content 212 is “ [symbol] ”. The time distribution of the text content 216 is: an occurrence time of “ [symbol] ” is from the 1^{st} to the 3^{rd} second, an occurrence time of “ [symbol] ” is from the 3^{rd} to the 5^{th} second, an occurrence time of “ [symbol] ” is from the 5^{th} to the 6^{th} second, and an occurrence time of “ [symbol] ” is from the 6^{th} to the 7^{th} second.

The second sequence part 219-2 includes a first set of melody elements corresponding to the first melody information and a time distribution corresponding to melody elements of the first set of melody elements. The first set of melody elements indicates melody elements included in the first melody information. The second sequence part 219-2 is determined by the model training system according to the first set of melody information and second time information 221 corresponding to the first set of melody information. For example, the occurrence time of the melody element “do” in the first set of melody information is from the 3^{rd} to the 4^{th} second.

The first sequence part 219-1 and the second sequence part 219-2 are used to construct the first training sequence 218. The first training sequence 218 may be represented as [word1.w_dur1.word2.w_dur2 . . . note1, n_dur1.note2.n_dur2 . . . ]. The “word1”, “word2”, and the like in first training sequence 218 indicate the respective lyrics elements, and the “w_dur1”, and “w_dur2” in the text content 216 indicate a time distribution of each of the lyrics elements. The “note1” and “note2” indicate respective melody elements corresponding to the first melody information, and the “n_dur1” and “n_dur2” indicate a time distribution corresponding to respective melody element in the first melody information.

After the first training sequence 218 is encoded, the first training sequence 218 is provided to the music generation model 223 to train the music generation model 223. Since both text (e.g., the text content 216 and the first melody information) and numbers (e.g., the time distribution) are present in the first training sequence 218, in some embodiments, the first training sequence 218 may be encoded with a text digital hybrid encoder 222. The first training sequence 218 is provided to the text digital hybrid encoder 222 to encode, generating a hybrid encoded representation with generalized performance. The hybrid encoded representation can better support processing of the music generation model 223. Therefore, the training effect on the music generation model 223 may be improved.

The hybrid encoded representation is provided to the music generation model 223. The music generation model 223 may be an autoregressive model that includes a plurality of decoder models, and the sequence data is generated by an output of the previous time step as an input to the next time step. The music generation model 223 generates a first set of music encoded representations 224 corresponding to the first training sequence 218 according to the provided hybrid encoded representation. The first set of music encoded representations 224 includes a plurality of predicted token features 225. For example, a predicted token feature 225-1, and a predicted token feature 225-2 may be separately or collectively referred to as predicted token features 225. The first set of music encoded representations 224 may be converted into music sound waves by a conversion model.

In some embodiments, the parameter of the music generation model 223 may be updated based on the first set of music encoded representations 224 produced by the music generation model 223 and the second set of music encoded representations 232 corresponding to the music sample 210 to train the music generation model 223. The second set of music encoded representations 232 indicate a real token feature of the music sample 210.

In some embodiments, the second set of music encoded representations 232 may be an encoding obtained after processing the first audio content 212 with a trained discrete encoder 230. Specifically, audio information of the first audio content 212 is extracted by using the discrete encoder 230 to obtain the token feature 231-1, the token feature 231-2, and the like. The obtained token features may be individually or collectively referred to as token features 231.

The model training system compares the first set of music encoded representations with the second set of music encoded representations based on a loss function, to determine a training loss of the music generation model 223. Based on the training loss, a parameter of the music generation model 223 is updated.

In the training process shown in FIG. 2, the music generation model 223 is trained based on the low-quality music sample 210 without using a large amount of high-quality data, and the training difficulty of the model is reduced. Meanwhile, the music sample 210 is annotated by using the text generation model and the melody recognition model 214 in the training process, without manual annotation of the music sample 210. In this way, on one hand, the labor cost in the training process is reduced. On the other hand, the duration of the phoneme is predicted without using an additional duration prediction model, and the modeling difficulty is reduced.

In order to further improve the performance of the music generation model 223, the pre-trained music generation model 223 may be subjected to supervised fine-tuning (SFT) by using manually annotated high-quality vocal track singings. Since the music generation model 223 has completed pre-training, it is possible to greatly reduce the high-quality vocal track singing and workload that need to be used by the supervised fine-tuning.

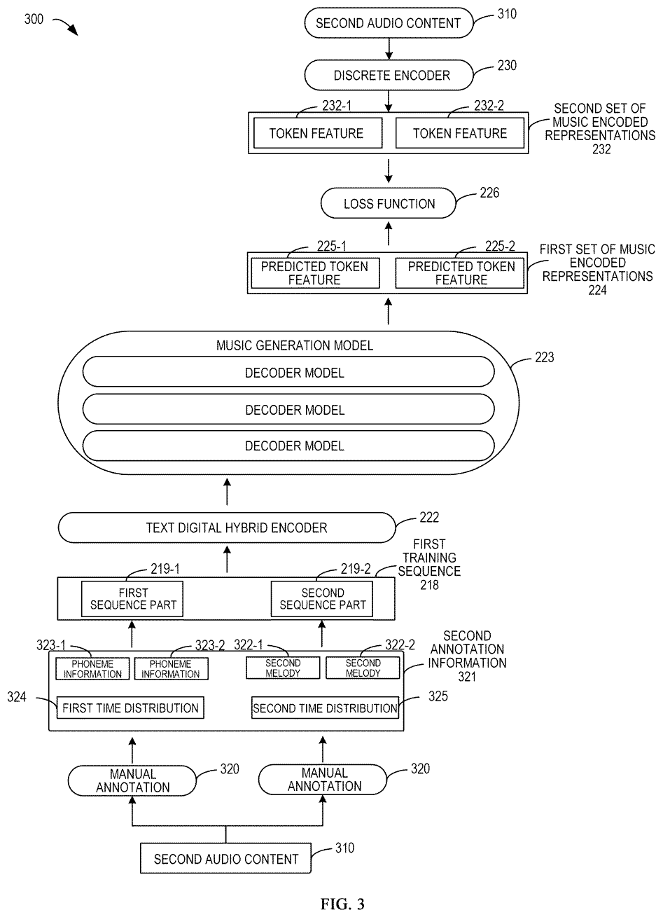

FIG. 3 illustrates an example architecture diagram of one example of a model fine-tuning system 300 according to some embodiments of the present disclosure. As shown in FIG. 3, the model fine-tuning system may be implemented or included in the electronic device 140. The electronic device 140 is configured to perform supervised fine-tuning on the music generation model 223 based on the music generation model 223 trained by the model training system and according to the high-quality vocal track singing provided by the user, further improving the performance of the music generation model 223.

As shown in FIG. 3, second audio content 310 indicates the high-quality vocal track singing. After the second audio content 310 is manually annotated, second annotation information 321 is generated. The second annotation information 321 includes phoneme information (e.g., phoneme information 323-1 and phoneme information 323-2, which may be individually or collectively referred to as phoneme information 323) corresponding to the second audio content 310 and second melody information of the second audio content 310. The second melody information includes second melodies 322-1 and 322-2, which may be individually or collectively referred to as second melody 322.

The second annotation information 321 indicates a plurality of phonemes corresponding to the second audio content 310 and a first time distribution 324 corresponding to the plurality of phonemes, and/or a second set of melody elements corresponding to the second audio content 310 and a second time distribution 325 corresponding to the second set of melody elements. The second set of melody elements indicate melody elements included in the second melody information, and the second melody information indicates a melody element corresponding to the second audio content 310. The manner of determining the first time distribution 324 and the second time distribution 325 is the same as the model pre-training process, and details are not described herein again.

In some embodiments, the second annotation information 321 may be information generated by manual annotation. The second annotation information 321 obtained after the high-quality voice track singing is manually annotated is provided to the music generation model 223, to train the music generation model 223. The predicted token feature 225 output by the music generating model 223 is compared with the token feature corresponding to the second audio content 310 to determine a training loss. A parameter of the music generation model 223 is fine-tuned based on the training loss. It can be seen that the music generation model 223 is pre-trained by the low-quality music sample 210 that may be relatively easily obtained, and the model parameter is fine-tuned by the high-quality music sample (that is, the second audio content 310) to obtain a music generation model 223 having high performance. In this way, an amount of high-quality music samples (i.e., the second audio content 310) used in the training process may be reduced, reducing the training cost.

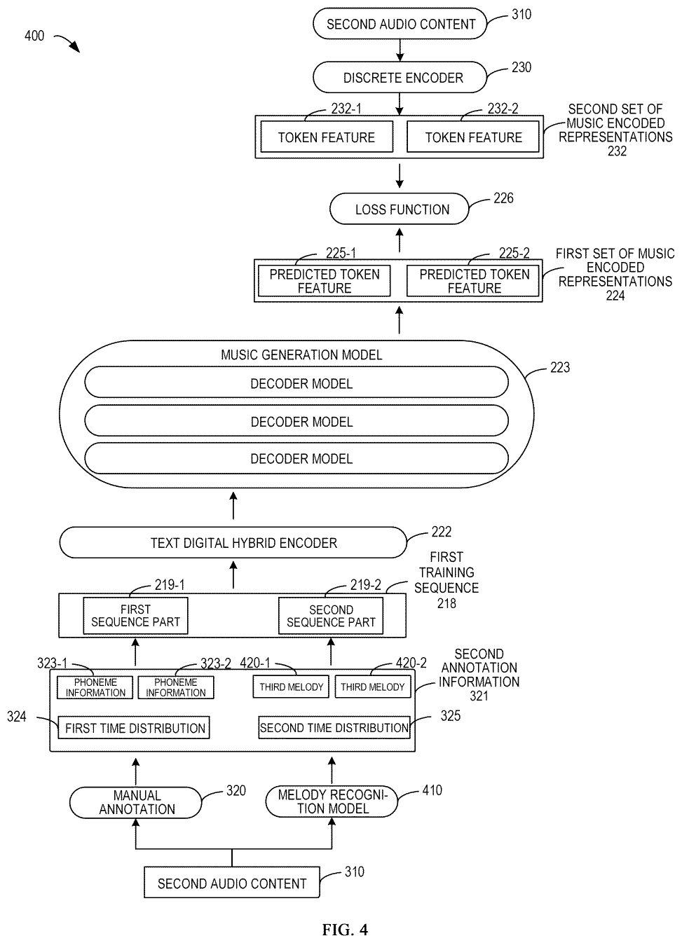

FIG. 4 illustrates an example architecture diagram of another example of a model fine-tuning system 400 according to some embodiments of the present disclosure. As shown in FIG. 4, the model fine-tuning system 400 may generate the second annotation information 321 based on the melody recognition model 214.

In some embodiments, the melody information of the second audio content 310 is annotated by using the melody recognition model 214 to determine a third set of melody elements 520. As shown in FIG. 4, a melody 410-1 and a melody 410-2 may be individually or collectively referred to as a third melody 410.

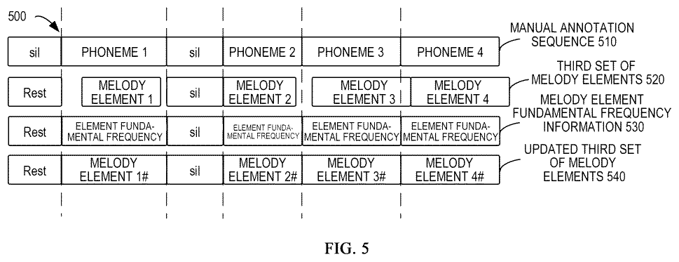

FIG. 5 illustrates an example architecture diagram of an example of a melody element 500 according to some embodiments of the present disclosure. As shown in FIG. 5, compared with the manually refined manual annotation sequence 510, the third set of melody elements 520 generated by the melody recognition model 214 have problems of unconnected boundary, inaccurate duration, and the like. In order to ensure the model training effect, the third melody 410 needs to be aligned with the phoneme information 323 generated by manual annotation.

Specifically, for a target time segment corresponding to a target phoneme in the first time distribution 324, at least one melody element corresponding to the target time segment is determined based on the third set of melody elements 520. A target melody element corresponding to the target time segment is determined based on the at least one melody element. The third set of melody elements 520 are updated with the target melody element. As shown in FIG. 5, the melody element 1 and the melody element 2 are not connected therebetween. The melody element 1 needs to be adjusted to align the melody element 1 with the phoneme 1.

In some embodiments, the target melody element may be determined based on a fundamental frequency of the melody element within the time segment. Specifically, a fundamental frequency of each melody element in each third set of melody elements 520 may be determined by a fundamental frequency predictor to generate melody element fundamental frequency information 530. The target melody element is determined based on a median fundamental frequency of the melody phoneme in each time segment. The melody element is updated with the target melody element to generate an updated third set of melody elements 540. As shown in FIG. 5, for a case in which the target melody element is the melody element 1 in FIG. 5, a target time segment in which the melody element 1 is located is first determined. The fundamental frequency of the element in the target time segment is determined, and the melody element 1 #is determined based on a median of the fundamental frequency of the element.

Continuing with FIG. 4, based on the updated third set of melody elements 540, the first training sequence 218 is constructed. The first training sequence 218 is encoded and then provided to the music generation model 223. The training loss of the music generation model 223 is determined based on the music generation model 223 generating the first set of music encoded representations 224 and the second set of music encoded representations 232 corresponding to the second audio content 310. The model parameter is fine-tuned based on the training loss. It can be seen that the melody element is determined by the melody recognition model 214, and the melody element is aligned with the manual annotation data. Thus, the workload of manual annotation and the training cost can be reduced on the basis of not influencing the model performance.

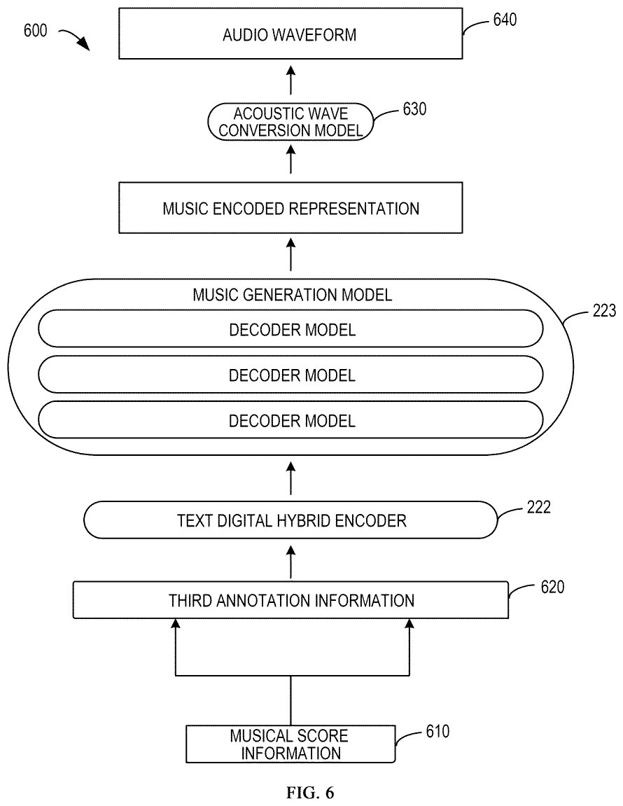

FIG. 6 illustrates an example architecture diagram of an example of a music generation system 600 according to some embodiments of the present disclosure. As shown in FIG. 6, the music generation system may be implemented or included in electronic device 140. The music generation system is configured to generate music according to the musical score input by the user.

As shown in FIG. 6, musical score information 610 includes text and melody related to a song. Third annotation information 620 is determined by parsing the musical score information 610. The third annotation information 620 includes text content 216, phoneme information 323, and melody information related to the musical score. The third annotation information 620 is encoded by the text digital hybrid encoder 222 and provided to the trained music generation model 223. The music generation model 223 generates a music encoded representation 630 including a token feature according to the input hybrid encoding. The music encoded representation 630 is provided into an acoustic wave conversion model 640 (token2wav), combined with a vocoder by a diffusion model of the acoustic wave conversion model 640, the audio feature corresponding to the music encoded representation 630 is converted into an audio waveform 650. The diffusion model is configured to convert the music encoded representation 630 into an implicit audio feature with higher sampling rate and more implicit information. The vocoder is configured to map the implicit audio feature into an audio waveform 650 to be output.

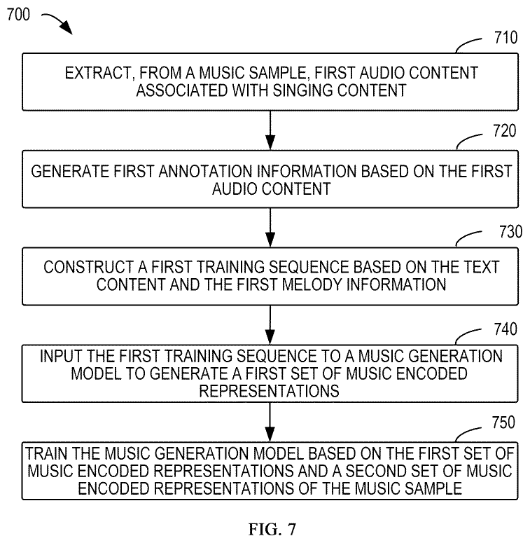

FIG. 7 illustrates a flowchart of a process 700 of training a model according to some embodiments of the present disclosure. The process 700 may be implemented at the electronic device 140.

At block 710, first audio content associated with vocal content is extracted from a music sample.

At block 720, first annotation information is generated based on the first audio content. The first annotation information includes text content corresponding to the first audio content and first melody information of the first audio content.

In some embodiments, generating the first annotation information includes: processing the first audio content with a text recognition model to determine the text content; and/or processing the first audio content with a melody recognition model to determine the first melody information.

At block 730, a first training sequence is constructed based on the text content and the first melody information.

In some embodiments, constructing the first training sequence based on the text content and the first melody information includes: constructing a first sequence part corresponding to the text content, based on the text content and first time information corresponding to the text content; constructing a second sequence part corresponding to the first melody information, based on the first melody information and second time information corresponding to the first melody information; and constructing the first training sequence based on the first sequence part and the second sequence part.

In some embodiments, the first sequence part indicates a plurality of lyrics elements and a time distribution corresponding to the plurality of lyrics elements, and/or the second sequence part indicates a first set of melody elements and a time distribution corresponding to the first set of melody elements.

At block 740, a first training sequence is input to a music generation model to generate a first set of music encoded representations.

In some embodiments, inputting the first training sequence to the music generation model includes: encoding the first training sequence with a text digital hybrid encoder to generate a hybrid encoded representation; and inputting the hybrid encoded representation to the music generation model.

At block 750, the music generation model is trained based on the first set of music encoded representations and a second set of music encoded representations of the music sample.

In some embodiments, training the music generation model based on the first set of music encoded representations and the second set of music encoded representations of the music sample includes: determining a training loss based on a comparison of the first set of music encoded representations and the second set of music encoded representations; and updating a model parameter of the music generation model based on the training loss.

In some embodiments, the process 700 further includes: processing the first audio content with a trained discrete encoder to determine the second set of music encoded representations.

In some embodiments, the process 700 further includes: obtaining sampled second audio content, the second audio content corresponding to a voice track; obtaining second annotation information of the second audio content, the second annotation information including phoneme information corresponding to the second audio content and second melody information of the second audio content; and fine-tuning the music generation model based on the second annotation information of the second audio content.

In some embodiments, the second annotation information indicates: a plurality of phonemes corresponding to the second audio content, and a first time distribution corresponding to the plurality of phonemes; and/or a second set of melody elements corresponding to the second audio content, and a second time distribution corresponding to the second set of melody elements.

In some embodiments, the process 700 further includes: processing the second audio content with a melody recognition model to generate a third set of melody elements; and updating the third set of melody elements based on the first time distribution of the plurality of phonemes to determine the second set of melody elements.

In some embodiments, updating the third set of melody elements based on the first time distribution of the plurality of phonemes includes: determining, for a target time segment of the first time distribution corresponding to a target phoneme, at least one melody element corresponding to the target time segment based on the third set of melody elements; determining a target melody element corresponding to the target time segment based on the at least one melody element; and updating the third set of melody elements with the target melody element.

In some embodiments, determining the target melody element corresponding to the target time segment based on the at least one melody element includes: determining a fundamental frequency median corresponding to the target time segment based on the at least one melody element; and determining the target melody element based on the fundamental frequency median.

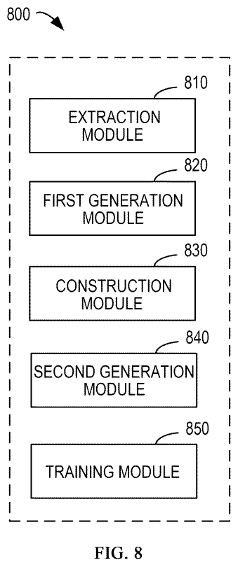

FIG. 8 is a schematic structural block diagram of an apparatus 800 for training a model according to some embodiments of the present disclosure. The apparatus 800 may be implemented or included in the electronic device. Various modules/components in the apparatus 800 may be implemented by hardware, software, firmware, or any combination thereof.

As shown in FIG. 8, the apparatus 800 includes an extraction module 810 configured to extract, from a music sample, first audio content associated with vocal content. The apparatus 800 further includes a first generation module 820 configured to generate first annotation information based on the first audio content, the first annotation information including text content corresponding to the first audio content and first melody information of the first audio content. The apparatus 800 further includes a construction module 830 configured to construct a first training sequence based on the text content and the first melody information. The apparatus 800 further includes a second generation module 840 configured to input the first training sequence to a music generation model to generate a first set of music encoded representations. The apparatus 800 further includes a training module 850 configured to train the music generation model based on the first set of music encoded representations and a second set of music encoded representations of the music sample.

In some embodiments, the first generation module 820 is further configured to process the first audio content with a text recognition model to determine the text content; and/or process the first audio content with a melody recognition model to determine the first melody information.

In some embodiments, the construction module 830 is further configured to construct a first sequence part corresponding to the text content, based on the text content and first time information corresponding to the text content; construct a second sequence part corresponding to the first melody information, based on the first melody information and second time information corresponding to the first melody information; and construct the first training sequence based on the first sequence part and the second sequence part.

In some embodiments, the second generation module 840 is further configured to encode the first training sequence with a text digital hybrid encoder to generate a hybrid encoded representation; and input the hybrid encoded representation to the music generation model.

In some embodiments, the training module 850 is further configured to determine a training loss based on a comparison of the first set of music encoded representations and the second set of music encodings; and update a model parameter of the music generation model based on the training loss.

In some embodiments, the apparatus 800 further includes a generation module for the second set of music encoded representation, configured to process the first audio content with a trained discrete encoder to determine the second set of music encoded representations.

In some embodiments, the apparatus 800 further includes a fine-tuning module configured to obtain sampled second audio content, the second audio content corresponding to a vocal track; obtain second annotation information of the second audio content, the second annotation information including phoneme information corresponding to the second audio content and second melody information of the second audio content; and fine-tune the music generation model based on the second annotation information of the second audio content.

In some embodiments, the apparatus 800 further includes a determination module for the second set of melody elements, configured to process the second audio content with a melody recognition model to generate a third set of melody elements; and update the third set of melody elements based on the first time distribution of the plurality of phonemes to determine the second set of melody elements.

In some embodiments, the apparatus 800 further includes an updating module for the third set of melody elements, configured to determine, for a target time segment of the first time distribution corresponding to a target phoneme, at least one melody element corresponding to the target time segment based on the third set of melody elements; determine a target melody element corresponding to the target time segment based on the at least one melody element; and update the third set of melody elements with the target melody element.

In some embodiments, the apparatus 800 further includes a determination module for the target melody element, configured to determine a fundamental frequency median corresponding to the target time segment based on the at least one melody element; and determine the target melody element based on the fundamental frequency median.

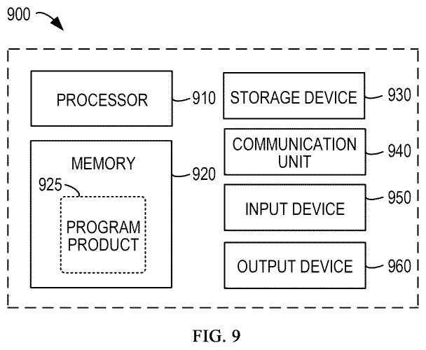

FIG. 9 illustrates a block diagram illustrating an electronic device 900 in which one or more embodiments of the present disclosure may be implemented. It should be understood that the electronic device 900 illustrated in FIG. 9 is merely illustrative and should not constitute any limitation on the functionality and scope of the embodiments described herein. The electronic device 900 shown in FIG. 9 may be configured to implement the electronic device 140 in FIG. 1.

As shown in FIG. 9, the electronic device 900 is in the form of a general-purpose electronic device. Components of the electronic device 900 may include, but are not limited to, one or more processors or processing units 910, a memory 920, a storage device 930, one or more communication units 940, one or more input devices 950, and one or more output devices 960. The processor 910 may be an actual or virtual processor and capable of performing various processes according to programs stored in the memory 920. In a multiprocessor system, a plurality of processing units executes computer-executable instructions in parallel to improve the parallel processing capability of the electronic device 900.

The electronic device 900 generally includes a plurality of computer storage media. Such media may be any available media that is accessible by the electronic device 900, including, but not limited to, volatile and non-volatile media, removable and non-removable media. The memory 920 may be a volatile memory (e.g., a register, a cache, a random access memory (RAM)), a non-volatile memory (e.g., a read-only memory (ROM), an electrically erasable programmable read-only memory (EEPROM), a flash memory), or some combination thereof. The storage device 930 may be a removable or non-removable medium and may include a machine-readable medium, such as a flash drive, a magnetic disk, or any other medium, which may be capable of storing information and/or data and may be accessed within the electronic device 900.

The electronic device 900 may further include additional removable/non-removable, volatile/non-volatile storage media. Although not shown in FIG. 9, a disk drive for reading from or writing into a removable, nonvolatile magnetic disk (e.g., a “floppy disk”) and an optical disk drive for reading from or writing into a removable, nonvolatile optical disk may be provided. In these cases, each drive may be connected to a bus (not shown) by one or more data media interfaces. The memory 920 may include a computer program product 925 having one or more program modules configured to perform various methods or actions of various embodiments of the disclosure.

The communication unit 940 is configured to communicate with other electronic devices through a communication medium. Additionally, the functionality of components of the electronic device 900 may be implemented in a single computing cluster or multiple computing machines capable of communicating through a communication connection. Thus, the electronic device 900 may operate in a networked environment using logical connections with one or more other servers, a network profile computer (PC), or another network node.

The input device 950 may be one or more input devices, such as a mouse, a keyboard, a trackball, or the like. The output device 960 may be one or more output devices, such as a display, a speaker, a printer, or the like. The electronic device 900 may also communicate with one or more external devices (not shown) through the communication unit 940 as needed, the external device such as a storage device, a display device, etc., communicates with one or more devices that enable the user to interact with the electronic device 900, or communicates with any device (e.g., a network card, a modem, etc.) that enables the electronic device 900 to communicate with one or more other electronic devices. Such communication may be executed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, the computer program product being tangibly stored on a non-transitory computer-readable medium and including computer-executable instructions, and the computer-executable instructions being executed by the processor to implement the method described above.

Aspects of the disclosure are described herein with reference to flowcharts and/or block diagrams of a method, an apparatus, a device, and a computer program product implemented in accordance with the disclosure. It should be understood that each block of the flowchart and/or block diagram, and combinations of blocks in the flowchart(s) and/or block diagram(s), may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in one or more blocks in the flowchart(s) and/or block diagram(s). These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in one or more blocks in the flowchart(s) and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on the computer, other programmable data processing apparatus, or other apparatus implement the functions/acts specified in one or more blocks in the flowchart(s) and/or block diagram(s).

The flowchart and block diagrams in the figures show an architecture, functionality, and operation that may be possibly implemented by a system, a method, and a computer program product according to various implementations of the disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagram(s) and/or flowchart(s), as well as combinations of blocks in the block diagram(s) and/or flowchart(s), may be implemented with a dedicated hardware-based system that performs the specified functions or actions, or may be implemented in a combination of dedicated hardware and computer instructions.

Various implementations of the disclosure have been described above, which are illustrative, not exhaustive, and are not limited to the implementations disclosed. Many modifications and variations will be apparent to those of ordinary skill in the art without departing from the scope and spirit of various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method of training a model, comprising:
extracting, from a music sample, first audio content associated with vocal content;
generating first annotation information based on the first audio content, the first annotation information comprising text content corresponding to the first audio content and first melody information of the first audio content;
constructing a first training sequence based on the text content and the first melody information;
inputting the first training sequence to a music generation model to generate a first set of music encoded representations; and
training the music generation model based on the first set of music encoded representations and a second set of music encoded representations of the music sample.

2. The method of claim 1, wherein generating the first annotation information comprises:
processing the first audio content with a text recognition model to determine the text content; and/or
processing the first audio content with a melody recognition model to determine the first melody information.

3. The method of claim 2, wherein constructing the first training sequence based on the text content and the first melody information comprises:
constructing a first sequence part corresponding to the text content, based on the text content and first time information corresponding to the text content;
constructing a second sequence part corresponding to the first melody information, based on the first melody information and second time information corresponding to the first melody information; and
constructing the first training sequence based on the first sequence part and the second sequence part.

4. The method of claim 3, wherein:
the first sequence part indicates a plurality of lyrics elements and a time distribution corresponding to the plurality of lyrics elements, and/or
the second sequence part indicates a first set of melody elements and a time distribution corresponding to the first set of melody elements.

5. The method of claim 1, further comprising:
processing the first audio content with a trained discrete encoder to determine the second set of music encoded representations.

6. The method of claim 1, wherein training the music generation model based on the first set of music encoded representations and the second set of music encoded representations of the music sample comprises:
determining a training loss based on a comparison of the first set of music encoded representations and the second set of music encoded representations; and
updating a model parameter of the music generation model based on the training loss.

7. The method of claim 1, wherein inputting the first training sequence to the music generation model comprises:
encoding the first training sequence with a text digital hybrid encoder to generate a hybrid encoded representation; and
inputting the hybrid encoded representation to the music generation model.

8. The method of claim 1, further comprising:
obtaining sampled second audio content, the second audio content corresponding to a voice track;
obtaining second annotation information of the second audio content, the second annotation information comprising phoneme information corresponding to the second audio content and second melody information of the second audio content; and
fine-tuning the music generation model based on the second annotation information of the second audio content.

9. The method of claim 8, wherein the second annotation information indicates:
a plurality of phonemes corresponding to the second audio content, and a first time distribution corresponding to the plurality of phonemes; and/or
a second set of melody elements corresponding to the second audio content, and a second time distribution corresponding to the second set of melody elements.

10. The method of claim 9, further comprising:
processing the second audio content with a melody recognition model to generate a third set of melody elements; and
updating the third set of melody elements based on the first time distribution of the plurality of phonemes to determine the second set of melody elements.

11. The method of claim 10, wherein updating the third set of melody elements based on the first time distribution of the plurality of phonemes comprises:
determining, for a target time segment of the first time distribution corresponding to a target phoneme, at least one melody element corresponding to the target time segment based on the third set of melody elements;
determining a target melody element corresponding to the target time segment based on the at least one melody element; and
updating the third set of melody elements with the target melody element.

12. The method of claim 11, wherein determining the target melody element corresponding to the target time segment based on the at least one melody element comprises:
determining a fundamental frequency median corresponding to the target time segment based on the at least one melody element; and
determining the target melody element based on the fundamental frequency median.

13. An electronic device, comprising:
at least one processor; and
at least one memory coupled to the at least one processor and storing instructions for execution by the at least one processor, the instructions, when executed by the at least one processor, causing the electronic device to perform acts comprising:
extracting, from a music sample, first audio content associated with vocal content;
generating first annotation information based on the first audio content, the first annotation information comprising text content corresponding to the first audio content and first melody information of the first audio content;
constructing a first training sequence based on the text content and the first melody information;
inputting the first training sequence to a music generation model to generate a first set of music encoded representations; and
training the music generation model based on the first set of music encoded representations and a second set of music encoded representations of the music sample.

14. The electronic device of claim 13, wherein generating the first annotation information comprises:
processing the first audio content with a text recognition model to determine the text content; and/or
processing the first audio content with a melody recognition model to determine the first melody information.

15. The electronic device of claim 14, wherein constructing the first training sequence based on the text content and the first melody information comprises:
constructing a first sequence part corresponding to the text content, based on the text content and first time information corresponding to the text content;
constructing a second sequence part corresponding to the first melody information, based on the first melody information and second time information corresponding to the first melody information; and
constructing the first training sequence based on the first sequence part and the second sequence part.

16. The electronic device of claim 13, wherein the acts further comprise:
processing the first audio content with a trained discrete encoder to determine the second set of music encoded representations.

17. The electronic device of claim 13, wherein training the music generation model based on the first set of music encoded representations and the second set of music encoded representations of the music sample comprises:
determining a training loss based on a comparison of the first set of music encoded representations and the second set of music encoded representations; and
updating a model parameter of the music generation model based on the training loss.

18. The electronic device of claim 13, wherein inputting the first training sequence to the music generation model comprises:
encoding the first training sequence with a text digital hybrid encoder to generate a hybrid encoded representation; and
inputting the hybrid encoded representation to the music generation model.

19. The electronic device of claim 13, wherein the acts further comprise:
obtaining sampled second audio content, the second audio content corresponding to a voice track;
obtaining second annotation information of the second audio content, the second annotation information comprising phoneme information corresponding to the second audio content and second melody information of the second audio content; and
fine-tuning the music generation model based on the second annotation information of the second audio content.

20. A non-transitory computer-readable storage medium having a computer program stored thereon, wherein the computer program is executable by a processor to perform acts comprising:
extracting, from a music sample, first audio content associated with vocal content;
generating first annotation information based on the first audio content, the first annotation information comprising text content corresponding to the first audio content and first melody information of the first audio content;
constructing a first training sequence based on the text content and the first melody information;
inputting the first training sequence to a music generation model to generate a first set of music encoded representations; and
training the music generation model based on the first set of music encoded representations and a second set of music encoded representations of the music sample.
